(19) United States
(12) Patent Application Publication
(10) Pub. No.: US 2015/0041576 A1
(43) Pub. Date: Feb. 12, 2015

(54) TWISTED HELICAL CUTTING SHAFT OR GEAR FOR A SHREDDER

(71) Applicant: Fellowes, Inc., Itasca, IL (US)

(72) Inventor: Vadim ROMANOVICH, Glen Ellyn, IL (US)

(73) Assignee: Fellowes, Inc., Itasca, IL (US)

(21) Appl. No.: 13/964,497

(22) Filed: Aug. 12, 2013

(51) Int. Cl. B02C 18/18; B23P 15/28; B02C 18/00

(52) U.S. Cl. CPC B02C 18/18; B02C 18/0007; B23P 15/28
USPC 241/236; 76/115

(57) ABSTRACT

A method of forming a rotatable cutting shaft member having a longitudinal axis and a plurality of axially spaced cutter elements for shredding substrates that are inserted in an opening in a housing of a shredder, in which the shaft member is a part of a shredder mechanism that is activated by a motor in the housing, is provided. The method includes turning opposing end portions of at least a longitudinal section of the rotatable cutting shaft member relative to one another in opposite directions about the longitudinal axis so as to twist at least the longitudinal section of the rotatable cutting shaft member to a predetermined helix angle; and mounting the plurality of axially spaced cutter elements on the rotatable cutting shaft member. The predetermined helix angle orients the plurality of axially spaced cutter elements on at least the longitudinal section in a helical arrangement.

### BACKGROUND

1. Field

The present disclosure is generally related to an apparatus having cutter elements for destroying a plurality of articles such as paper and discs. In particular, the present disclosure provides a method of forming a rotatable cutting shaft member with a predetermined helix angle that orients a plurality of axially spaced cutter elements in a helical arrangement.

2. Description of Related Art

Shredders are well known devices for destroying substrate articles, such as documents, CDs, floppy disks, etc. Typically, users purchase shredders to destroy sensitive articles, such as credit card statements with account information, documents containing company trade secrets, etc.

A shredder generally has a shredder mechanism contained within a housing that is removably mounted atop a container. The housing has a feed opening that enables substrates to be fed into the shredder mechanism. The shredder mechanism includes a cutting assembly that shreds data bearing substrates such as paper and discs fed therein. The cutting assembly includes a plurality of axially spaced cutter elements arranged on a pair of rotatable cutting shaft members in an interleaved manner for shredding substrates.

During operation of the shredder, paper or other articles are fed through the feed or input opening or throat of the shredder to be destroyed. When paper is fed through the throat of the shredder, the paper travels into the cutting assembly where it is shredded into smaller particles. The particles then exit through an outlet of the housing, and accumulate inside the container or waste bin.

Generally, there are two types of cutting mechanisms that are used in the shredders, one is a straight-cut or strip cutting mechanism and the other is a cross-cut cutting mechanism. The shredder with the straight-cut cutting mechanism cuts the paper generally along the feeding direction to produce long, thin strips of paper. The shredder with the cross-cut cutting mechanism cuts in both feeding direction and a direction transverse to the feeding direction to create paper particles or small paper chips. The cross-cut cutting mechanism generally comprises a pair of parallel, straight rotatable cutting shaft members that contain a plurality of offset cutter elements arranged along the axis of the shaft members. The cutter elements of the cross-cut cutting mechanism are indexed to adjust their rotational position with respect to the other cutter elements. That is, the cutter elements of the cross-cut cutting mechanism are mounted to the shaft member and manually oriented during the placement to create a helical configuration for its teeth.

### SUMMARY

According to one aspect of the present disclosure, a method of forming a rotatable cutting shaft member is provided. The rotatable cutting shaft member has a longitudinal axis and a plurality of axially spaced cutter elements for shredding substrates that are inserted in an opening in a housing of a shredder, in which the shaft member is a part of a shredder mechanism that is activated by a motor in the housing, the motor rotating the shaft member to rotate the plurality of axially spaced cutter elements thereon. The method includes turning opposing end portions of at least a longitudinal section of the rotatable cutting shaft member relative to one another in opposite directions about the longitudinal axis so as to twist at least the longitudinal section of the rotatable cutting shaft member to a predetermined helix angle; and mounting the plurality of axially spaced cutter elements on the rotatable cutting shaft member. The predetermined helix angle orients the plurality of axially spaced cutter elements on at least the longitudinal section in a helical arrangement.

According to another aspect of the present disclosure, a shredder for shredding substrates is provided. The shredder includes a shredder housing; a substrate receiving opening provided on the housing; a shredder mechanism received in the housing and comprising a pair of rotatable cutting shaft members each provided with a plurality of axially spaced cutter elements and a motor for rotating the shaft members, wherein at least one of the pair of the rotatable cutting shaft members is formed by turning opposing end portions of at least a longitudinal section of the rotatable cutting shaft member relative to one another in opposite directions about its longitudinal axis so as to twist at least the longitudinal section of the rotatable cutting shaft member to a predetermined helix angle, wherein the predetermined helix angle orients the plurality of axially spaced cutter elements on at least the longitudinal section of the rotatable cutting shaft member in a helical arrangement.

According to yet another aspect of the present disclosure, a method of forming a shaft member having a longitudinal axis and a plurality of teeth extending radially therefrom and integrally formed on at least a portion of the shaft, in which the shaft member is a part of a shredder mechanism that is activated by a motor, is provided. The method includes turning opposing end portions of at least a longitudinal portion of the shaft member relative to one another in opposite directions about the longitudinal axis so as to twist at least the longitudinal portion of the shaft member and the plurality of teeth disposed thereon to a predetermined helix angle and to form a helical tooth profile.

Other objects, features, and advantages of one or more embodiments of the present disclosure will seem apparent from the following detailed description, and accompanying drawings, and the appended claims.

### BRIEF DESCRIPTION OF THE DRAWINGS

Various embodiments will now be disclosed, by way of example only, with reference to the accompanying schematic drawings in which corresponding reference symbols indicate corresponding parts, in which

FIG. 1 is a perspective view of a shredder in accordance with an embodiment of the present disclosure;

FIG. 2 is an exploded perspective view of the shredder of FIG. 1;

FIGS. 3A-3C show a rotatable cutting shaft member that is used in a shredder mechanism of the shredder;

FIGS. 4A-4C show the rotatable cutting shaft member of FIGS. 3A-3C after the rotatable cutting shaft member is twisted to a predetermined helix angle in accordance with an embodiment of the present disclosure;

FIGS. 5A-5C show a pair of rotatable cutting shaft members with a plurality of axially spaced cutter elements positioned thereon in accordance with an embodiment of the present disclosure;

FIGS. 6A-6C show a gear blank with a motor rotated pinion formed thereon, wherein the motor rotated pinion is made from a prior art manufacturing procedure;

FIGS. 7A-7C show a gear blank with a motor rotated pinion having straight tooth profile formed thereon;

FIGS. 8A-8C show the gear blank of FIGS. 7A-7C after the motor rotated pinion is twisted to a predetermined helix angle in accordance with an embodiment of the present disclosure;

FIGS. 9A-9C show another gear blank with a motor rotated pinion having straight tooth profile formed thereon, wherein the tooth profile is formed throughout the length of the gear blank;

FIGS. 10A-10C show the gear blank of FIGS. 9A-9C after the gear blank is twisted to a predetermined helix angle in accordance with an embodiment of the present disclosure; and

FIGS. 11A-11C show the rotatable cutting shaft member of FIGS. 3A-3C after the rotatable cutting shaft member is twisted by moving start and end positions of clamp portions axially along the cutting shaft member and then rotating one half of the cutting shaft member in one direction to a predetermined helix angle and the second half of the cutting shaft member in the opposite direction to the same predetermined helix angle in accordance with an embodiment of the present disclosure so as to provide a herringbone shaped configuration to the cutting shaft member.

### DETAILED DESCRIPTION

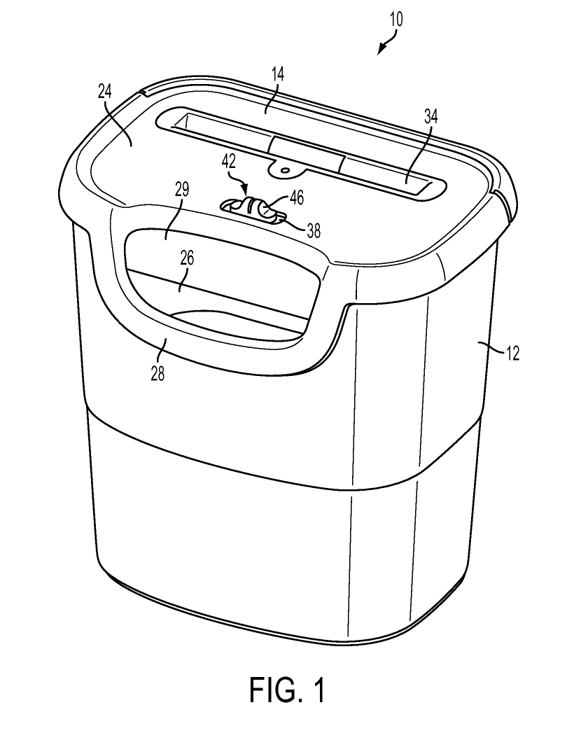

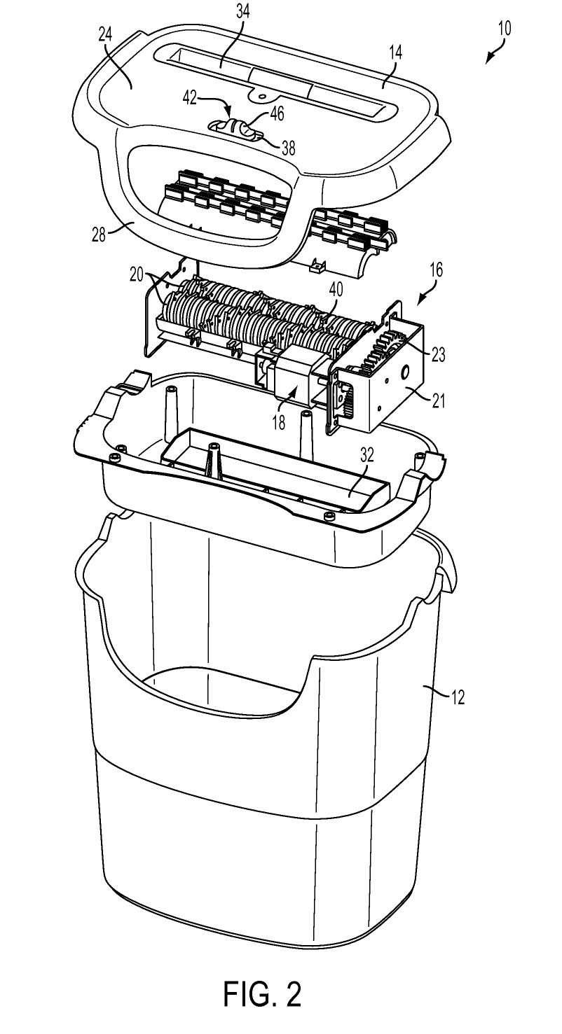

FIGS. 1-2 illustrate a substrate destruction apparatus in accordance with an embodiment of the present disclosure. The substrate destruction apparatus is generally indicated at 10 and is designed to destroy multiple articles such as paper and discs. The apparatus 10 sits on top of a container 12, which may be a waste container or waste bin. In one embodiment, the apparatus 10 includes a housing 14 that sits on an upper periphery of the container 12 in a nested relation. However, the apparatus 10 may be of the type provided with an adaptable mount for attachment to a wide variety of containers. Generally speaking, the apparatus 10 may have any suitable construction or configuration and the illustrated embodiment is not intended to be limiting in any way.

The apparatus 10 includes a substrate destruction mechanism 16 in the housing 14, and includes a drive system with at least one motor, such as an electrically powered motor 18, and a plurality of cutter elements 40. The motor 18 operates using electrical power to rotatably drive cutting shaft members 20 and their corresponding cutter elements 40 through a conventional transmission 23 so that the cutter elements shred or destroy articles fed therein. In the illustrated embodiment only one motor is shown; however, the drive system may have any number of motors, and may include one or more transmissions. The plurality of axially spaced cutter elements 40 are mounted on the rotatable cutting shaft members 20 in manner as explained in detail below. The substrate destruction mechanism 16 also may include a sub-frame 21 for mounting the cutting shaft members 20, the motor 18, and the transmission 23, for example.

The housing 14 includes a top wall 24 that sits atop container 12. In one embodiment, the top wall 24 is molded from plastic and has an opening 26 near the front thereof. The opening 26 is formed in part by a downwardly depending generally U-shaped member 28. The opening 26 allows waste to be discarded into the container 12 without being passed through the substrate destruction mechanism 16. The member 28 may act as a handle for carrying the apparatus 10 separate from the container 12. As an optional feature, the opening 26 may be provided with a lid, such as a pivoting lid, that opens and closes the opening 26. However, this opening is general is optional and may be omitted entirely. Moreover, the housing 14 and its top wall 24 may have any suitable construction or configuration.

The housing 14 may include a bottom receptacle 29 having a bottom wall, four side walls, and an open top. The substrate destruction mechanism 16 is received therein, and the receptacle 29 is affixed to the underside of the top wall 24. The receptacle 29 may be fixed to the underside of the top wall 24 by fasteners, for example. In one embodiment, the receptacle 29 has a downwardly facing opening 32 for permitting destroyed articles to be discharged from the substrate destruction mechanism 16 into the container 12.

The top wall 24 has a switch recess 38 with an opening (not shown) there through. An on/off switch 42 includes a switch module (not shown) mounted to the top wall 24 underneath the recess 38 by fasteners, and a manually engageable portion 46 that moves laterally within the recess 38. The switch module may have a movable element (not shown) that connects to the manually engageable portion 46 through the opening. This enables movement of the manually engageable portion 46 to move the switch module between its states.

The switch module connects the motor 18 to the power supply (not shown). Typically, the power supply will be a standard power cord (not shown) with a plug (not shown) on its end that plugs into a standard AC outlet, but any suitable manner of power delivery may be used. The switch 42 is movable between an on position and an off position by moving the manually engageable portion 46 laterally within the recess 38. In the on position, contacts in the switch module are closed by movement of the manually engageable portion 46 and the movable element to enable a delivery of electrical power to the motor 18. In the off position, contacts in the switch module are opened to disable the delivery of electric power to the motor 18.

Optionally, the switch 42 may also have a reverse position wherein contacts are closed to enable delivery of electrical power to operate the motor 18 in a reverse manner. This would be done by using a reversible motor and applying a current that is of a reverse polarity relative to the on position. The capability to operate the motor 18 in a reversing manner is desirable to move the cutter elements 40, such as those on the first rotating shaft member 20, in a reversing direction for clearing jams. In an embodiment, in the off position the manually engageable portion 46 and the movable element would be located generally in the center of the recess 38, and the on and reverse positions would be on opposing lateral sides of the off position.

Generally, the construction and operation of the switch 42 for controlling the motor 18 are well known and any construction for such a switch 42 may be used. For example, instead of a mechanical switch, a sensor based switch may be used. See U.S. Pat. No. 7,757,982, the entirety of which is incorporated herein by reference. Likewise, the presence of a main power switch may be omitted, and the switches in the feed openings may be triggered, simply by insertion of paper or discs.

The top cover 24 may also include another recess associated with an optional switch lock. Generally, switch lock may be constructed to move the switch 42 from the on and/or reverse position to the off position as the switch lock moves from the releasing position to the locking position by any suitable arrangement known in the art. The switch lock is an optional feature and is not necessary. Its use is beneficial for preventing inadvertent actuation of the on/off switch. Other features may also be used, such as the proximity sensor or other devices as shown in U.S. Patent Application Publication Nos. 2006/0054724 A1, 2006/0054725 A1, and 2006/0219827 A1, the entirety of each of which is incorporated herein by reference. Again, any such device is optional and should not be regarded as limiting.

The housing 14 also has a generally laterally extending opening 34 provided thereon. The opening 34 extends generally parallel to each other on the top wall 24 and above the cutter elements 40. The opening 34, often referred to as a throat, enables the articles being destroyed to be fed into the cutter elements 40. As can be appreciated, the substrate receiving opening 34 is relatively narrow, which is desirable for preventing overly thick items, such as large stacks of documents or multiple discs, from being fed into the cutter elements 40, which could lead to jamming. The opening 34 may have any configuration. In one embodiment, the opening 34 is of a length to accommodate the insertion of paper of standard sizes (e.g., 8.5×11 inches paper or A4 paper). For example, the length of opening 34 may be about 9 inches or greater (for accommodating 8.5×11 inches or A4 paper). Also, the opening 34 may have a thickness, for example, that is greater than 1.2 millimeters (mm), such as of at least 1.4 mm, for permitting insertion of only one disc (or multiple discs) at a time. However, the length and/or the thickness of the opening 34 should not be limited to this embodiment. The opening 34 may be designed to receive credit cards or other similar substrates.

The plurality of axially spaced cutter elements 40 are mounted on the rotatable cutting shaft members 20 in any suitable manner. For example, the cutter elements 40 are positioned along the rotatable cutting shaft members 20 such that the cutter elements 40 on each rotatable cutting shaft member are received in an interleaving relationship with the cutter element 40 of the other rotatable cutting shaft member. This interleaving allows the overlapping portions of adjacent cutter elements to cut paper or other substrates in a scissors-like manner in the feeding direction.

In one embodiment, the cutter element 40 generally comprises one or more radial projections on at least a portion thereof. The radial projections are effective in both the paper shredding and disc destruction directions and modes. In one embodiment, the radial projections include cross cutting teeth to cross cut substrate into pieces. U.S. Pat. Nos. 5,636,801, 5,676,321, 5,829,697, 5,954,280, 7,637,448 and 7,677,483, the entirety of each of which is incorporated herein by reference, describe exemplary cutter elements in great detail. Cross-cutting refers to cuts transverse to the feeding direction, whereby cutting in both directions creates paper particles or chips.

A spacer may be disposed between adjacent cutter elements. Generally, a spacer is provided between each adjacent cutter elements. In one embodiment, the spacer may be integral with the body of the cutter element. Alternately, the spacer may be a separate component that provides distance between individual cutter elements on the cutting shaft member. If the spacer is a separate component, it may be attached or affixed to the body of the cutter element or the shaft member. Any method of attachment presently known in the art may be used to attach the spacer to the body of the cutter element or the shaft member. In one embodiment, the spacer may be substantially circular and has a diameter greater than that of the shaft member and smaller than that of the cutter elements. U.S. Pat. Nos. 5,636,801, 5,676,321, 5,829,697, 5,954,280, and 7,637,448, the entirety of each of which is incorporated herein by reference, describe exemplary spacers in great detail.

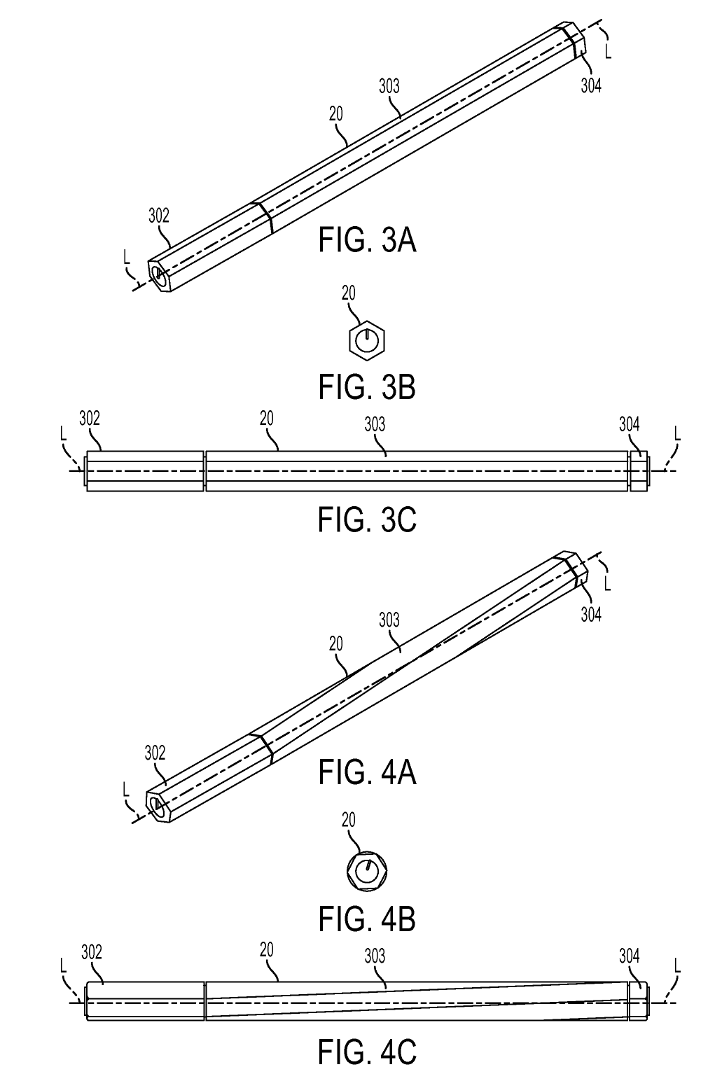

FIGS. 3A-3C show an exemplary rotatable cutting shaft member that is to be used in a shredder mechanism and FIGS. 4A-4C show the rotatable cutting shaft member of FIGS. 3A-3C after the rotatable cutting shaft member is twisted to a predetermined helix angle in accordance with an embodiment of the present disclosure. Specifically, FIGS. 3A and 4A show perspective views of the rotatable cutting shaft member, while FIGS. 3B and 4B show side views of the rotatable cutting shaft member, and FIGS. 3C and 4C show front views of the rotatable cutting shaft member.

As shown in FIGS. 3A-3C, the rotatable cutting shaft member 20 has a hexagon-shaped configuration. However, it is contemplated that the rotatable cutting shaft member 20 of the present disclosure may have other shaped configurations. Such configurations are non-circular to enable rotational mating with the cutter elements. The rotatable cutting shaft member 20 has a longitudinal axis L-L, a first end portion 302 and an opposite second end portion 304. The term “relative to one another” is used to denote that both ends may be turned in opposing rotational directions, or either end may be stationary and the other end may be turned. Either approach effects relative turning to create the helix angle.

The method of the present disclosure includes turning the first end portion 302 and the second end portion 304 of the rotatable cutting shaft member 20 relative to one another in opposite directions about the longitudinal axis L-L so as to twist the rotatable cutting shaft member 20 to a predetermined helix angle.

In one embodiment, the predetermined helix angle orients the plurality of axially spaced cutter elements 40 in a helical arrangement on the rotatable cutting shaft member 20. In one embodiment, the predetermined helix angle has a range between 10 and 180 degrees. In another embodiment, the predetermined helix angle has a range between 60 and 90 degrees.

In one embodiment, the procedure of twisting or turning the rotatable cutting shaft member 20 is done using a device having a first clamp portion and a second clamp portion. The first clamp portion is configured to retain the first end portion 302 of the rotatable cutting shaft member 20 therein and the second clamp portion is configured to retain the second end portion 304 of the rotatable cutting shaft member 20 therein. In one embodiment, the first clamp portion and the second clamp portion are configured to receive the rotatable cutting shaft member 20 having different shapes and configurations. The first and the second clamp portions of the device may be operatively associated with one or more actuators of the device. The one or more actuators may be configured to rotate one or more of the first and the second clamp portions about the longitudinal axis L-L.

For example, in one embodiment, the one or more actuators may be configured to only rotate the first clamp portion. The first clamp portion may be rotated in a clockwise or anti-clockwise direction. In this embodiment, the second clamp portion and the second end portion 304 retained therein are both at their rest positions (i.e., stationary). The rotational movement of the first clamp portion causes the first end portion 302 of the rotatable cutting shaft member 20 to turn about the longitudinal axis L-L relative to the second end portion 304 and thereby twist the rotatable cutting shaft member 20 to a predetermined helix angle.

In another embodiment, the one or more actuators may be configured to only rotate the second clamp portion. The second clamp portion may be rotated in a clockwise or anti-clockwise direction. In this embodiment, the first clamp portion and the first end portion 302 retained therein are both at their rest positions (i.e., stationary). The rotational movement of the second clamp portion causes the second end portion 304 of the rotatable cutting shaft member 20 to turn about the longitudinal axis L-L relative to the first end portion 302 and thereby twist the rotatable cutting shaft member 20 to a predetermined helix angle.

In yet another embodiment, the one or more actuators may be configured to rotate both the first clamp portion and the second clamp portion in opposite directions about the longitudinal axis L-L. The first clamp portion may be rotated in a clockwise direction and the second clamp portion may be rotated in counter clockwise direction or vice versa. The rotational movement of the first clamp portion and the second clamp portion causes the first end portion 302 and the second end portion 304 of the rotatable cutting shaft member 20 to turn about the longitudinal axis L-L relative to one another so as to twist the rotatable cutting shaft member 20 to a predetermined helix angle.

FIGS. 4A-4C show the rotatable cutting shaft member 20 of FIGS. 3A-3C after the rotatable cutting shaft member 20 is twisted to a predetermined helix angle.

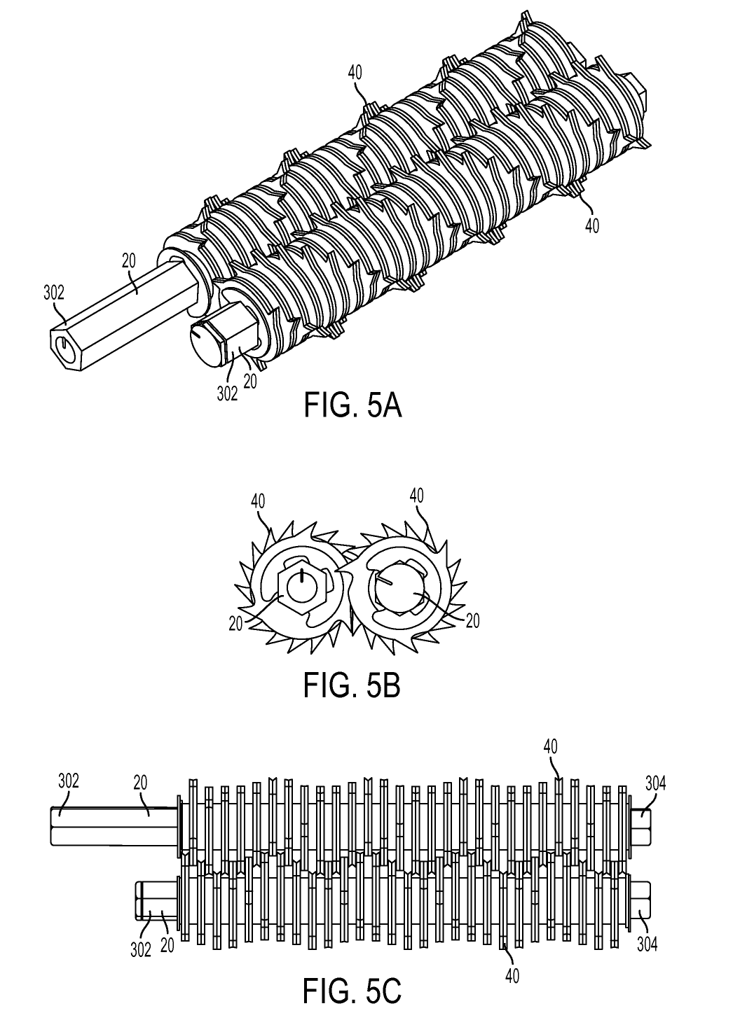

The method of the present disclosure also includes mounting the plurality of axially spaced cutter elements 40 on the rotatable cutting shaft member 20. FIGS. 5A-5C show a pair of rotatable cutting shaft members 20 with a plurality of axially spaced cutter elements 40 positioned thereon in accordance with an embodiment of the present disclosure. Specifically, FIG. 5A shows a perspective view of the pair of rotatable cutting shaft members 20 with the plurality of axially spaced cutter elements 40 positioned thereon, while FIG. 5B shows a side view and FIG. 5C shows a front view of the pair of rotatable cutting shaft members 20 with the plurality of axially spaced cutter elements 40 positioned thereon.

In one embodiment, the plurality of axially spaced cutter elements 40 is mounted to the rotatable cutting shaft member 20 after the turning procedure described above. In another embodiment, the plurality of axially spaced cutter elements 40 is mounted to the rotatable cutting shaft member 20 before the turning procedure described above.

If the cutter elements 40 are mounted to the rotatable cutting shaft member 20 before the turning procedure, they can be mounted in a circumferential alignment, and the turning will create the angular rotation to arrange the cutter element teeth helically. Also, when the plurality of axially spaced cutter elements 40 is mounted to the rotatable cutting shaft member 20 before the turning procedure, the plurality of axially spaced cutter elements 40 may be locked in place during the twisting/turning procedure. That is, the assembly including the rotatable cutting shaft member 20 and the plurality of axially spaced cutter elements 40 positioned/stacked thereon is turned/twisted. As the rotatable cutting shaft member 20 twists, plurality of axially spaced cutter elements 40 positioned/stacked thereon may be locked in place on the rotatable cutting shaft member 20. Therefore, there is no need for any expensive machined grooves on the rotatable cutting shaft member that are generally used for positioning the plurality of axially spaced cutter elements on the rotatable cutting shaft member.

In the cross-cut shredders, the cutter elements may be indexed to adjust their rotational position with respect to the other cutter elements. The indexing of the cutter elements may result in a level of complexity that makes manual stacking very difficult and expensive. The method, according to the embodiments of the present disclosure, reduces this complexity and also speeds up shaft assembly. For example, there is no need to index the cutter elements and/or spacers positioned between the cutter elements when stacking them on the rotatable cutting shaft member. When the plurality of axially spaced cutter elements 40 is mounted to the rotatable cutting shaft member 20 after the turning procedure, the cutter elements 40 are automatically indexed circumferentially with respect to the other cutter elements 40 as they are being stacked on the twisted rotatable cutting shaft member 20. That is the predetermined helix angle of the rotatable cutting shaft member 20 orients the plurality of axially spaced cutter elements 40 in a helical arrangement.

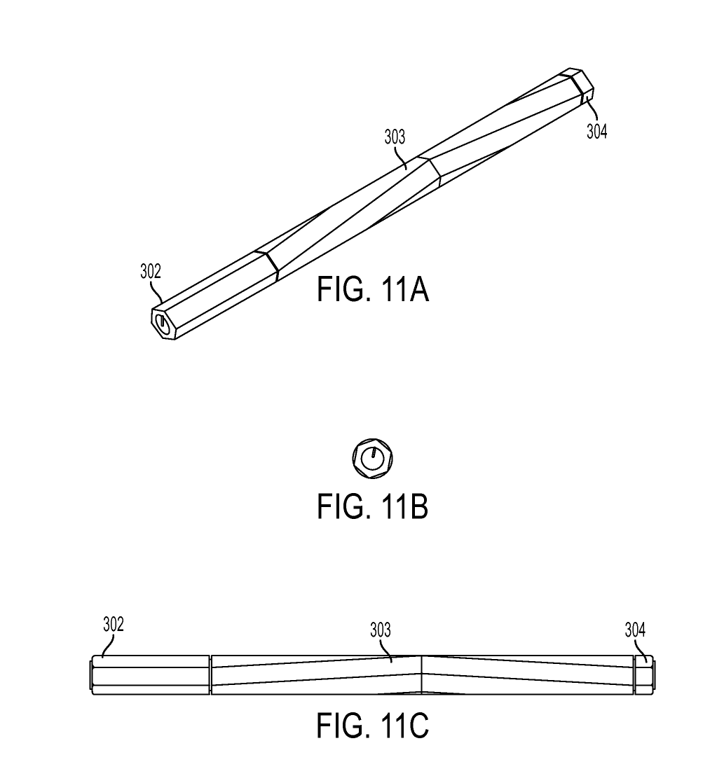

FIGS. 11A-11C show the rotatable cutting shaft member of FIGS. 3A-3C after the rotatable cutting shaft member is twisted to a predetermined double helix angle to provide a herringbone shaped configuration to the rotatable cutting shaft member. A herringbone shaped configuration, as used herein, generally refers to a type of double helical shaped configuration formed by two opposite hand helical shaped configurations. For example, as shown in FIGS. 11A and 11C, the herringbone shaped configuration of the rotatable cutting shaft member looks like letter V.

In one embodiment, the herringbone shaped configuration of the rotatable cutting shaft member is formed by moving the start and end positions for the clamp portions axially along the cutting shaft member, and then rotating one half of the cutting shaft member in one direction to a predetermined helix angle, and the second half of the cutting shaft member in the opposite direction to the same predetermined helix angle.

Specifically, in one embodiment, only two clamp members are used to provide the herringbone shaped configuration to the cutting shaft member. In such an embodiment, the two clamp members are moved axially along the cutting shaft member to desired locations before twisting the cutting shaft member. That is, the two clamp members are positioned at the first end portion and a mid-section portion 303 of the cutting shaft member and then the first half of the cutting shaft member (between the first end portion and the mid-section portion) is twisted in one direction to a predetermined helix angle. After twisting the first half of the cutting shaft member, the two clamp members are then moved axially along the cutting shaft member to be positioned at the second end portion and the mid-section portion of the cutting shaft member. The second half of the cutting shaft member (between the second end portion and the mid-section portion) is then twisted in opposite direction to the same predetermined helix angle so as to provide a herringbone shaped configuration to the cutting shaft member.

In another embodiment, three clamp portions may be used to provide herringbone shaped configuration to the cutting shaft member. That is, the first clamp portion is configured to retain the first end portion 302 of the cutting shaft member 20 therein, a third clamp portion is configured to retain the mid-section portion 303 of the cutting shaft member 20 therein, and the second clamp portion is configured to retain the second end portion 304 of the rotatable cutting shaft member 20 therein. For example, in one embodiment, the one or more actuators may be configured to rotate the first clamp portion in one direction to a predetermined helix angle and to rotate the second clamp portion in the opposite direction to the same predetermined helix angle.

In one embodiment, the first clamp portion may be rotated in a clockwise direction and the second clamp portion may be rotated in an anti-clockwise direction. In another embodiment, the first clamp portion may be rotated in an anti-clockwise direction and the second clamp portion may be rotated in a clockwise direction. In this embodiment, the third clamp portion and the mid-section portion 303 retained therein are both at their rest positions (i.e., stationary) during the turning or twisting procedures. The rotational movements of the first clamp portion and the second clamp portion cause the first end portion 302 and the second end portion 304 of the rotatable cutting shaft member 20 to turn about the longitudinal axis L-L relative to the mid-section portion 303 in opposite directions and thereby provide a herringbone shaped configuration to the rotatable cutting shaft member.

In one embodiment, the one or more actuators may be configured to first rotate the first clamp portion in one direction relative to the third clamp portion and then to rotate the second clamp portion in the opposite direction relative to the third clamp portion. In another embodiment, the one or more actuators may be configured to rotate both the first clamp portion and the second clamp portion in opposite directions at the same time, while the third clamp portion is being held stationary.

In one embodiment, the portion of the rotatable cutting shaft member 20 that is between the first end portion 302 and the mid-section portion 303 of the rotatable cutting shaft member 20 is twisted to a predetermined helix angle in one direction and the portion of the rotatable cutting shaft member 20 that is between the mid-section portion 303 and the second end portion 304 of the rotatable cutting shaft member 20 is twisted to the same predetermined helix angle but in opposite direction. That is, in one embodiment, the portion of the rotatable cutting shaft member 20 between the first end portion 302 and the mid-section portion 303 of the rotatable cutting shaft member 20 and the portion of the rotatable cutting shaft member 20 between the mid-section portion 303 and the second end portion 304 of the rotatable cutting shaft member 20 are twisted to opposite helix angles.

The rotatable cutting shaft members 20 of the shredder are generally driven by a drive system that includes the motor 18 and a series of gears and gear shafts. In one embodiment, the motor 18 includes a motor shaft that has an integral pinion (with a plurality of teeth).

The series of gears and gear shafts is configured to connect the motor shaft to a driving gear that may be arranged on the rotatable cutting shaft member near either end of the rotatable cutting shaft member. Although the drive system may have any number of gears and gear shafts, in one exemplary embodiment, the drive system may include a first gear shaft and a second gear shaft each having, for example, four gears mounted thereon. In one embodiment, all of the gears are free to rotate about their respective gear shafts.

The driving gear may include a plurality of engaging members disposed on an inner surface thereof that abut an outer surface of the rotatable cutting shaft member so as to prevent the driving gear from rotating about the rotatable cutting shaft member. When the rotatable cutting shaft member assembly is used in the shredder, the driving gear may be coupled to the series of gears and gear shafts that is in turn connected to the drive motor 18. During operation, the drive motor 18 drives and rotates its own gear (or gears) which in turn drives and rotates the driving gear. Since the driving gear is fixedly mounted, the rotatable cutting shaft member 20 will also be rotated.

A method of forming a pinion, a gear or any hobbed gear on a motor shaft is disclosed according to the embodiments of the present patent application. Specifically, a method of forming a shaft member that has a longitudinal axis, a first end portion, a second end portion, and a plurality of teeth extending radially therefrom and integrally formed on at least a portion of the shaft, in which the shaft member is a part of the shredder mechanism that is activated by the motor, is provided.

The method includes turning the first end portion and the second end portion of the shaft member relative to one another in opposite directions about the longitudinal axis so as to twist the shaft member and the plurality of teeth disposed thereon to a predetermined helix angle and form a helical tooth profile. In one embodiment, the shaft member is a shaft member of the motor.

A spur gear or a straight-cut gear is easier and faster to hob with better surface finish. Hobbing a helical gear is significantly harder than hobbing a spur gear. Typical problems for hobbing helical gears come from the limitations of the gear hob tooling, and the extra time and complexity of the required hobbing equipment. The method of the present application takes the spur gear and twists the spur gear to form the desired helix and thus combines the benefits of the helical gear forming process and the spur gear forming process. The method disclosed in the present application takes advantage of lower machining costs for the spur gear forming and forms the desired helix by simply twisting the formed spur gear. The helical gears formed according to the embodiments of the present patent application have advantages over the prior art spur gears in strength and noise. For example, the helical gears formed according to the embodiments of the present patent are formed at a lower cost, have a better tooth profile, and have a better surface finish for helical gears.

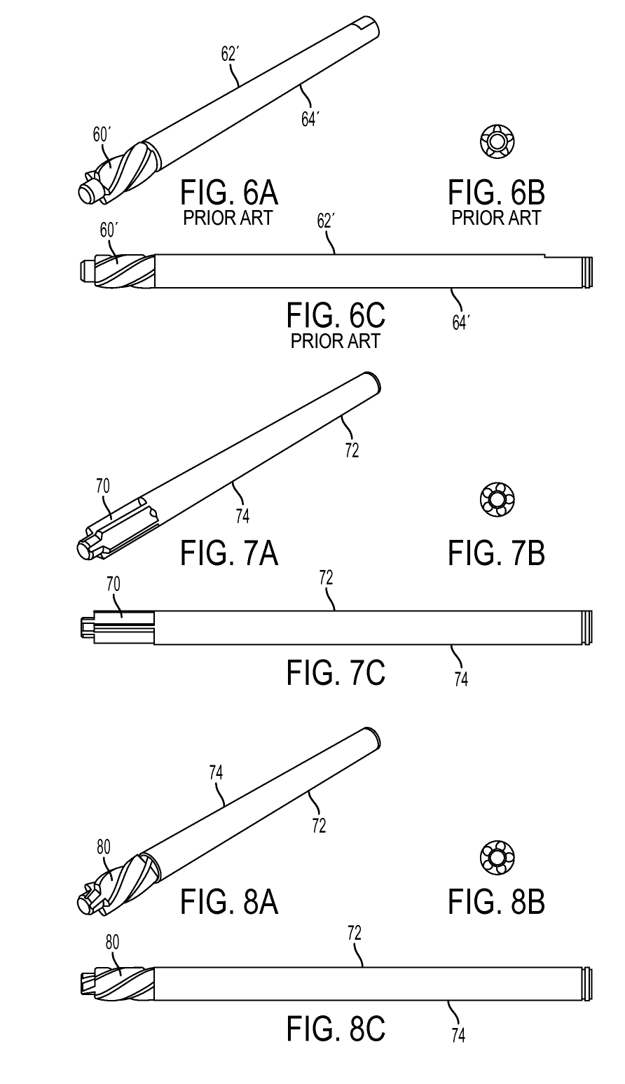

FIGS. 6A-6C show a gear blank with a motor rotated pinion formed thereon, wherein the motor rotated pinion is made from a prior art manufacturing procedure. Specifically, FIG. 6A shows a perspective view of a helical gear 60′ generated from an annular gear blank 62′ having a shaft 64′ by the action of a rotatable gear cutter (not shown) in a prior art manufacturing procedure, while FIG. 6B shows a side view and FIG. 6C shows a front view of the helical gear 60′ generated from the annular gear blank 62′. The helical gear 60′ shown in FIGS. 6A-6C is hobbed on the annular gear blank 62′ using a prior art manufacturing procedure. Hobbing the helical gear 60′ is significantly harder than hobbing a spur gear and is often associated with several limitations.

FIGS. 7A-7C show a gear blank with a motor rotated pinion having straight tooth profile formed thereon. Specifically, FIG. 7A shows a perspective view of a gear 70 with straight cut or broached tooth profile generated from an annular gear blank 72 having a shaft 74, while FIG. 7B shows a side view and FIG. 7C shows a front view of the gear 70 with straight cut or broached tooth profile generated from the annular gear blank 72.

In one embodiment, the method of forming a pinion, a gear or any hobbed gear on a motor shaft includes twisting the motor pinion or gear shaft 70 about its longitudinal axis to a predetermined helix angle so as to provide a helical configuration to that motor pinion or gear. For example, FIGS. 8A-8C show the motor rotated pinion of FIGS. 7A-7C after the motor rotated pinion is twisted to a predetermined helix angle in accordance with an embodiment of the present disclosure. Specifically, FIG. 8A shows a perspective view of a gear 80 with helical tooth profile generated from the annular gear blank 72 having the shaft 74, while FIG. 8B shows a side view and FIG. 8C shows a front view of the gear 80 with helical tooth profile generated from the annular gear blank 72.

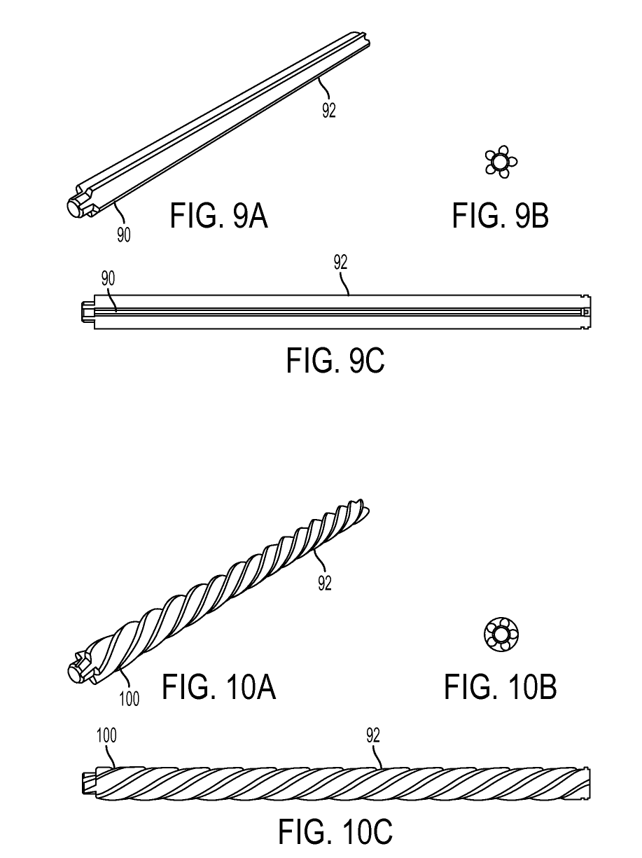

FIGS. 9A-9C another gear blank with a motor rotated pinion having straight tooth profile formed thereon, wherein the tooth profile is formed throughout the length of the gear blank. In contrast to the previous embodiment, the method of forming a motor pinion or any hobbed gear disclosed in the illustrated embodiments of FIGS. 9A-9C and 10A-10C includes twisting a full length gear blank about its longitudinal axis to a predetermined helix angle so as to provide a helical configuration to the motor pinion or gear. As shown in FIGS. 9A-9C and 10A-10C, the tooth profile is formed along the full length of the gear blank.

FIG. 9A shows a perspective view of a gear 90 with straight cut or broached tooth profile generated from a full length annular gear blank 92, while FIG. 9B shows a side view and FIG. 9C shows a front view of the gear 90 with straight cut or broached tooth profile generated from the full length annular gear blank 92.

In one embodiment, the method of forming a motor pinion or any hobbed gear includes twisting the full length annular gear blank 92 about its longitudinal axis to a predetermined helix angle so as to provide a helical configuration to the motor pinion or gear. For example, FIGS. 10A-10C show the motor rotated pinion of FIGS. 9A-9C after the full length annular gear blank is twisted to a predetermined helix angle in accordance with an embodiment of the present disclosure. Specifically, FIG. 10A shows a perspective view of a gear 100 with helical tooth profile generated from the full length annular gear blank 92, while FIG. 10B shows a side view and FIG. 10C shows a front view of the gear 100 with helical tooth profile generated from the full length annular gear blank 92.

In one embodiment, the method of forming the motor shaft member with the integral pinion includes turning a first end portion and a second end portion of the gear blank relative to one another in opposite directions about its longitudinal axis so as to twist the gear blank to a predetermined helix angle. In another embodiment, the method of forming the motor shaft member with the integral pinion includes turning a first end portion of the gear blank about its longitudinal axis and relative to a stationary second end portion of the gear blank so as to twist the gear blank to a predetermined helix angle. In yet another embodiment, the method of forming the motor shaft member with the integral pinion includes turning a second end portion of the gear blank about its longitudinal axis and relative to a stationary first end portion of the gear blank so as to twist the gear blank to a predetermined helix angle.

In one embodiment, the method of forming the motor shaft member with the integral pinion includes turning one half of the gear blank in one direction to a predetermined helix angle and then turning the second half of the gear blank in the opposite direction to the same predetermined helix angle so as to provide a herringbone shaped configuration to the motor shaft member. This can be achieved using three clamp members each positioned a first end portion, a mid-section portion and a second end portion of the gear blank, respectively. Alternatively, two clamp member configuration may be used in which the two clamp members may be moved to axially along the gear blank to desired positions, as discussed in detail above.

The cutter elements may be any type of cutter element known in the prior art. In one embodiment, the cutter elements may be either a straight cut type or a cross-cut type. In one embodiment, the cutter elements may be made out of any desirable material, such as metal or plastic, that has a strength and hardness sufficient for the intended cutting. In one embodiment, number or shape of teeth of the cutter elements could vary.

With the rotatable cutting shaft member, according to the embodiments of the present disclosure, there is also no need to perform multiple cutting operations (using multiple version of cutting devices) to obtain the desired helix angle.

While the present disclosure has been described in connection with what is presently considered to be the most practical and preferred embodiment, it is to be understood that it is capable of further modifications and is not to be limited to the disclosed embodiment, and this application is intended to cover any variations, uses, equivalent arrangements or adaptations of the present disclosure following, in general, the principles of the present disclosure and including such departures from the present disclosure as come within known or customary practice in the art to which the present disclosure pertains, and as may be applied to the essential features hereinbefore set forth and followed in the spirit and scope of the appended claims.

What is claimed is:

1. A method of forming a rotatable cutting shaft member having a longitudinal axis and a plurality of axially spaced cutter elements for shredding substrates that are inserted in an opening in a housing of a shredder, in which the shaft member is a part of a shredder mechanism that is activated by a motor in the housing, the motor rotating the shaft member to rotate the plurality of axially spaced cutter elements thereon, the method comprising:
turning opposing end portions of at least a longitudinal section of the rotatable cutting shaft member relative to one another in opposite directions about the longitudinal axis so as to twist at least the longitudinal section of the rotatable cutting shaft member to a predetermined helix angle; and
mounting the plurality of axially spaced cutter elements on the rotatable cutting shaft member,
wherein the predetermined helix angle orients the plurality of axially spaced cutter elements on at least the longitudinal section in a helical arrangement.

2. A method according to claim 1, wherein the rotatable cutting shaft member has first and second end portions and wherein the first and second end portions are turned relative to one another in the opposite directions so as to twist the rotatable cutting shaft member to the predetermined helix angle along substantially its entire length.

3. A method according to claim 2, wherein the plurality of axially spaced cutter elements is mounted to the rotatable cutting shaft member after the turning.

4. A method according to claim 3, wherein the cutter elements are automatically indexed circumferentially with respect to the other cutter elements as they are being stacked on the twisted rotatable cutting shaft member.

5. A method according to claim 2, wherein the plurality of axially spaced cutter elements is mounted to the rotatable cutting shaft member before the turning.

6. A method according to claim 5, wherein the plurality of axially spaced cutter elements is circumferentially locked in place during the turning.

7. A method according to claim 1, further comprising turning opposing end portions of another longitudinal section of the rotatable cutting shaft member relative to one another in opposite directions about the longitudinal axis so as to twist at least the another longitudinal section of the rotatable cutting shaft member to a predetermined helix angle.

8. A method according to claim 7, wherein the longitudinal sections are adjacent to one another and are twisted in opposite-handed directions to form a herringbone arrangement together.

9. A shredder for shredding substrates, comprising:
a shredder housing;
a substrate receiving opening provided on the housing;
a shredder mechanism received in the housing and comprising a pair of rotatable cutting shaft members each provided with a plurality of axially spaced cutter elements and a motor for rotating the shaft members,
wherein at least one of the pair of the rotatable cutting shaft members is formed by turning opposing end portions of the at least a longitudinal section of the rotatable cutting shaft member relative to one another in opposite directions about its longitudinal axis so as to twist at least the longitudinal section of the rotatable cutting shaft member to a predetermined helix angle,
wherein the predetermined helix angle orients the plurality of axially spaced cutter elements on at least the longitudinal section of the rotatable cutting shaft member in a helical arrangement.

10. A shredder according to claim 9, wherein the rotatable cutting shaft member has first and second end portions and wherein the first and second end portions of the rotatable cutting shaft member are turned relative to one another in the opposite directions so as to twist the rotatable cutting shaft member to the predetermined helix angle along substantially its entire length.

11. A shredder according to claim 10, wherein the plurality of axially spaced cutter elements is mounted to the rotatable cutting shaft member after the turning.

12. A shredder according to claim 11, wherein the cutter elements are automatically indexed circumferentially with respect to the other cutter elements as they are being stacked on the twisted rotatable cutting shaft member.

13. A shredder according to claim 10, wherein the plurality of axially spaced cutter elements is mounted to the rotatable cutting shaft member before the turning.

14. A shredder according to claim 13, wherein the plurality of axially spaced cutter elements is circumferentially locked in place during the turning.

15. A shredder according to claim 10, wherein at least the one of the pair of the rotatable cutting shaft members is formed turning opposing end portions of another longitudinal section of the rotatable cutting shaft member relative to one another in opposite directions about the longitudinal axis so as to twist at least the another longitudinal section of the rotatable cutting shaft member to a predetermined helix angle.

16. A shredder according to claim 15, wherein the longitudinal sections are adjacent to one another and are twisted in opposite-handed directions to form a herringbone arrangement together.

17. A method of forming a shaft member having a longitudinal axis and a plurality of teeth extending radially therefrom and integrally formed on at least a portion of the shaft, in which the shaft member is a part of a shredder mechanism that is activated by a motor, the method comprising:
turning opposing end portions of at least a longitudinal portion of the shaft member relative to one another in opposite directions about the longitudinal axis so as to twist at least the longitudinal section of the shaft member and the plurality of teeth disposed thereon to a predetermined helix angle and to form a helical tooth profile.

18. The method according to claim 17, wherein the shaft member is a shaft member of the motor.

19. A method according to claim 17, wherein the shaft member has first and second end portions and wherein the first and second end portions of the shaft member are turned relative to one another in the opposite directions so as to twist the shaft member to the predetermined helix angle along substantially its entire length.

20. A method according to claim 17, further comprising turning opposing end portions of another longitudinal section of the shaft member relative to one another in opposite directions about the longitudinal axis so as to twist at least the another longitudinal section of the shaft member to a predetermined helix angle, and wherein the longitudinal sections are adjacent to one another and are twisted in opposite-handed directions to form a herringbone arrangement together.
